(19) United States
(12) Patent Application Publication
(10) Pub. No.: US 2014/0227677 A1
(43) Pub. Date: Aug. 14, 2014

(54) PERFUSION OF PROSPECTIVE DONOR HEARTS WITH POLYMERIZED HEMOGLOBIN

(71) Applicant: OPK Biotech, LLC, Cambridge, MA (US)

(72) Inventor: Gregory P. Dube, Littleton, MA (US)

(73) Assignee: OPK Biotech, LLC, Cambridge, MA (US)

(21) Appl. No.: 14/175,367

(22) Filed: Feb. 7, 2014

Related U.S. Application Data
(60) Provisional application No. 61/762,283, filed on Feb. 7, 2013.

(51) Int. Cl. A01N 1/02

(52) U.S. Cl. CPC A01N 1/0226
USPC 435/1.2

(57) ABSTRACT

A prospective donor heart, such as a prospective donor human heart, is perfused with a polymerized hemoglobin-based oxygen carrier solution in a Langendorff mode or a working heart perfusion mode.

### RELATED APPLICATION

This application claims the benefit of U.S. Provisional Application No. 61/762,283, filed on Feb. 7, 2013. The entire teachings of the above application are incorporated herein by reference.

### BACKGROUND OF THE INVENTION

Standard care procedures for storing a perspective donor heart typically involve static cold storage (CS) in a cardioplegic solution. CS is suboptimal for myocardial preservation because it provides little oxygen to the heart, allowing ischemic insult to occur and limiting duration of the safe storage period, thereby constraining the available working time to transport the heart to the patient and to prepare the recipient. CS also results in deterioration in transmembrane ion balances that must be restored after transplantation before the heart can support life in the recipient. These limitations constrain the availability of hearts for transplantation, exacerbating a chronic shortage of donor organs. In addition, under CS conditions, it is not possible to assess cardiac condition and potential function of the heart prior to implantation, thereby imposing heightened risk to the recipient that could result in morbidity or death.

Perfusing hearts with blood or a mixture of blood and organ preservation solution will generally meet the oxygen requirements of the heart in either Langendorff or working modes if the hemoglobin concentration is sufficient. However, perfusing with a mixture containing blood has a different set of limitations, including the ethics of collecting the large volumes of donor blood required to support an ex vivo perfusion circuit. Also, RBCs may lyse over time in the perfusion circuit, resulting in unstable free hemoglobin that will have deleterious effects on the heart. Activation of leukocytes contained in blood by the perfusion circuit will generate cytokines and oxygen-derived free radicals, resulting in inflammation of and damage to the heart during reperfusion.

Therefore, there is a need for a method of preserving prospective donor hearts that overcome or minimize the above-referenced problems.

### SUMMARY OF THE INVENTION

The invention generally is directed to a method for perfusing a prospective donor heart, such as a human heart, in preparation for transplantation of that heart to a qualified recipient in need thereof

In one embodiment, the method for perfusing a heart includes the step of perfusing the heart with a polymerized hemoglobin-based oxygen carrier solution. In various embodiments, the polymerized hemoglobin-based oxygen carrier solution includes a polymerized hemoglobin component and an organ preservation solution component. In one embodiment, the polymerized hemoglobin-based oxygen carrier solution is perfused through the heart in a Langendorff mode. The polymerized hemoglobin component can be polymerized with at least one member of the group consisting of aldehydes and saccharides. An example of a preferred aldehyde is gluteraldehyde. An example of a preferred saccharide is o-raffinose. Preferably, the polymerized hemoglobin component is polymerized with the glutaraldehyde. Also, preferably, the polymerized hemoglobin component has an oxygen p50 are greater than about 30 mmHg. In a particular preferred embodiment the polymerized hemoglobin has a p50 of about 40 mmHg. Also, preferably, the polymerized hemoglobin component has a viscosity of less than about 4 cP and, most preferably, a viscosity of about 2.4 cP.

The present invention has many advantages. For example, the perfusion of a prospective donor heart by the method of the invention typically limits myocardial ischemia, extends the interval of safe preservation and improves post-transplant function compared with CS. These functional attributes may thereby allow recruitment of donor hearts that otherwise may have been too large (e.g., hearts from extended-criteria donors and donors after cardiac death (DCD)) for consideration of transplantation, thereby potentially expanding the heart donor pool and providing a greater opportunity for an appropriate match between donor and recipient. Further, because ex vivo perfusion with a hemoglobin-based oxygen carrier (HBOC) should yield donor hearts of higher quality that can be quantitatively verified prior to implantation in the recipient, the risk of a failed graft will be diminished and recipient morbidity and mortality should decrease.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic representation of an ex vivo perfusion circuit suitable for use by the method of the invention, wherein the perfusion is in a Langendorff perfusion mode.

FIG. 2 is a schematic representation of the ex vivo perfusion circuit of FIG. 1 in a working heart perfusion mode

### DETAILED DESCRIPTION OF THE INVENTION

A description of example embodiments of the invention follows.

The invention generally is directed to a method for perfusing a heart, such as a heart that is a prospective donor heart to a qualified recipient thereof. Examples of suitable prospective donor hearts include human hearts and hearts of other mammalian species suitable for harvesting in whole or in part, such as porcine, equine, bovine and other primates. A qualified recipient in need thereof is a recipient that would be recognized as a recipient in need of a donor heart for transplantation by one of skill in the art of heart transplantation, or a recipient in need of implantation of a component of a donor heart, such as the valve of a donor heart.

The method for perfusing a heart of the invention includes the step of perfusing the heart with a polymerized hemoglobin-based oxygen carrier (poly-HBOC) solution. The source of the hemoglobin employed to form the hemoglobin based oxygen carrier perfusate is a suitable source, such as are known in the art, including, for example, porcine, bovine, and other primate sources of hemoglobin.

Examples of suitable polymerized hemoglobin components include polymerized hemoglobin components that are polymerized with at least one member of the group insisted of aldehydes and saccharides. A preferred aldehyde is glutaraldehyde. A preferred saccharide is o-raffinose. Most preferably, the polymerized hemoglobin component is polymerized with glutaraldehyde.

In one embodiment, the polymerized hemoglobin is polymerized with glutaraldehyde and has an oxygen p50 of greater than about 30 mm Hg (mercury). In another embodiment, the polymerized hemoglobin component has a p50 of greater than about 35 mmHg. In still other embodiments, the polymerized hemoglobin component has an oxygen p50 of about 40 mmHg.

In another embodiment, the polymerized hemoglobin component is polymerized with glutaraldehyde and has a viscosity of less than about 4 cP (centipoise). Preferably, the polymerized hemoglobin component has a viscosity of less than about 3 cP and, even more preferably, a viscosity of less than about 2.5 cP. A particularly preferred embodiment employs a polymerized hemoglobin component having viscosity of about 2.4 cP.

In one embodiment, the poly-HBOC solution includes, in addition to a hemoglobin component, an “organ preservation solution” component. An “organ preservation solution,” as that term is employed herein, is a solution that is suitable for at least temporarily assisting in the preservation of an organ in preparation for transplant from a living donor to a living recipient. Such solutions typically include a colloid component, a metabolite component and an electrolyte component, and many such solutions are known in the art of organ transplantation. An example of a suitable organ preservation solution is a STEEN Solution™, manufactured by XVIVO Perfusion AB, of Sweden.

In another embodiment, the poly-HBOC solution includes an organ preservation solution component in an amount in a range of between about ten percent and about seventy-five percent by volume. Preferably the amount of organ preservation solution component in the poly-HBOC solution is about twenty-five percent.

In still another embodiment, the poly-HBOC solution has a temperature in a range of between about 4° C. and about 40° C. Preferably, the temperature of the solution is about 37° C.

A particularly preferred polymerized hemoglobin component of the poly-HBOC solution for use with the method of the invention is HBOC-201™, manufactured by OPK Biotech LLC (Cambridge, Mass.). In one embodiment, the average molecular weight of the polymerized hemoglobin-solution component is in a range of between 65 and about 800 kilodaltons (kDa). Preferably the average molecular weight is about 250 kDa. Examples of particularly preferred polymerized hemoglobin component of the poly-HBOC solution are described in, for example, U.S. Pat. Nos.: 5,618,919, 5,905,345, 6,506,725, 5,084,558, 5,296,465, 5,618,687, 5,095,765, 5,952,470, 5,695,951, 5,939,299, 5,854,209, 5,840,852, 5,955 581, 5,753,616, 5,895,810, 5,691,452, 6,271,337, 6,610,832, 6,288,027, 6,150,507, 6,541,449, 7,041,800, 7,041,799, 5,589,354, 5,854,054, 5,691,453, 5,808,011, 6,811,778, 7,267,817, 7,135,554, 7,459,535, 6,518,010, 6,986,984, 7,553,613, and 7,001,715, the relevant teachings of all of which are incorporated by reference herein in their entirety.

Typically, the heart is perfused ex vivo, although, under particular circumstances, the heart can be perfused by the method of the invention in vivo. Further, the donor heart can be perfused by the method of the invention by working heart perfusion. Alternatively, the donor heart can be perfused by the method of the invention in a retrograde manner, known as Langendorff perfusion. In one particular embodiment, the heart is perfused by directing the polymerized hemoglobin solution to the heart through the aorta of the heart. Alternatively, the heart is perfused by directing the polymerized hemoglobin solution into the heart through the left atrium of the heart in a “working heart perfusion mode.” In a preferred embodiment, the heart is perfused by Langendorff perfusion.

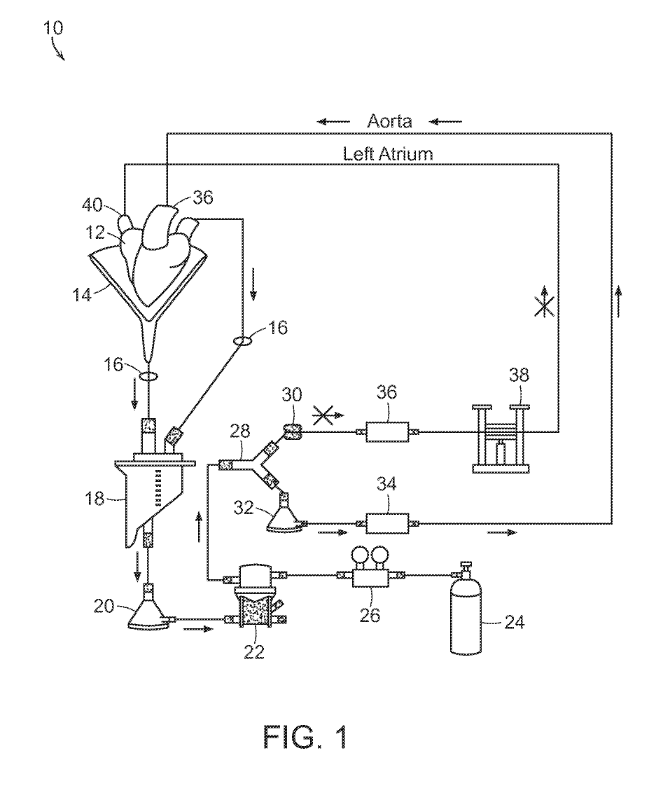

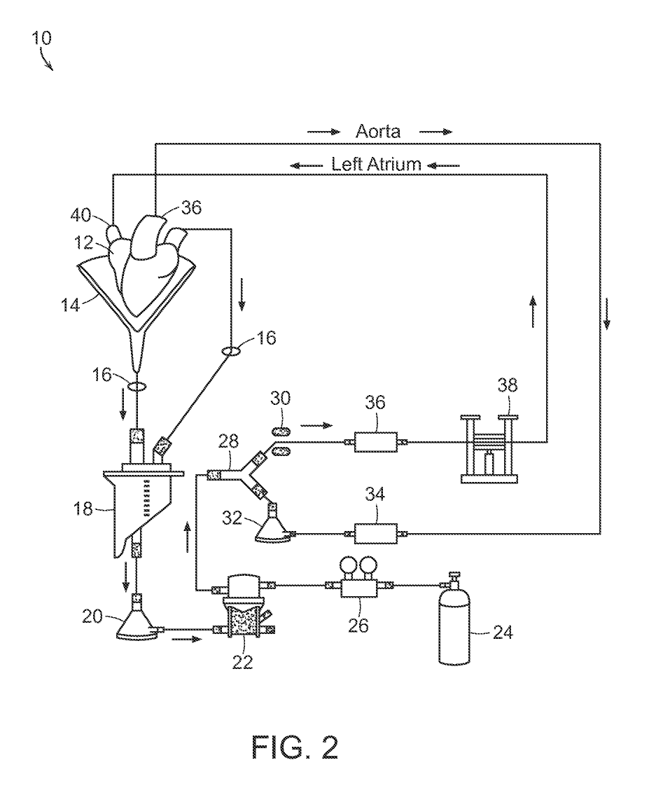

A typical apparatus 10 suitable for use by the method of the invention is shown in FIGS. 1 and 2. As shown therein, donor heart 12 is located over funnel 14 to scavenge blood from the inferior and superior vena cava of heart 12. Perfusate drains 16 into venous reservoir 18 which, in turn is in fluid communication with centrifugal pump 20. Centrifugal pump 20 directs the poly-HBOC solution to oxygenator 22, which oxygenates the poly-HBOC solution with oxygen supplied from oxygen supply 24 and through regulator 26, and directs the oxygenated poly-HBOC solution from oxygenator 22 to Y fitting 28. When valve 30 is closed, the poly-HBOC solution is directed through centrifugal pump 32 and flow probe 34 to aorta 36 of heart 12 as shown in FIG. 1. This is known as “Langendorff perfusion.” Alternatively, when valve 30 is open, as shown in FIG. 2, the oxygenated poly-HBOC solution is directed through flow probe 36 and left atrial pressure control 38 to left atrium 40 of heart 12. When valve is open, perfusion of heart 12 by the method of the invention is according to a “working heart perfusion” mode. It is to be understood that other suitable methods of directing perfusate through heart can be employed by Applicants' claimed method of perfusing a prospective heart with a hemoglobin-based oxygen carrier solution of the invention.

The following example is set forth as only a single embodiment, it is not intended to be a limitation of the invention.

### Exemplification

Hearts were perfused with a mixture of STEEN Solution™ and HBOC-201™ to achieve a final hemoglobin (Hb) concentration of 4.0 g/dL (HBOC-201-STEEN Solution™). Control hearts were perfused with a mixture of STEEN Solution™ and porcine blood to achieve a final Hb concentration of 4.0 g/dL (Blood-STEEN Solution™ group). HBOC-201-STEEN Solution™ hearts demonstrated superior myocardial energy metabolism vs. control as indicated by myocardial P³¹ high-energy phosphate species measured by nuclear magnetic resonance one hour after initiating heart perfusion. Specifically, the ratio of inorganic phosphate to creatine phosphate was lower in HBOC-201-STEEN Solution™ hearts (0.29±0.04) vs. control hearts (0.49±0.03) (P<0.01). A conductance catheter was placed in the left ventricle to assess cardiac function. Systolic function, as reflected by end systolic pressure-volume relationship (ESPVR) and diastolic function, as reflected by end diastolic pressure-volume relationship (EDPVR) were similar between the two treatment groups after one hour of perfusion (Table 1).

TABLE 1
Assessment of left ventricular function after one hour of perfusion

| | Blood-STEEN* | HBOC-STEEN** | p-value |
|---|---|---|---|
| Systolic Function | | | |
| ESPVR (mmHg) | 3.7 ± 0.9 | 4.2 ± 1.7 | 0.70 |
| Diastolic Function | | | |
| EDPVR (mmHg) | 0.29 ± 0.03 | 0.35 ± 0.05 | 0.30 |
| Tau (ms | 57 ± 6 | 64 ± 6 | 0.46 |

EDPVR, end-diastolic pressure-volume relationship; ESPVR, end-systolic pressure-volume relationship
*Blood-STEEN Solution ™ hearts
**HBOC-201 ™ - STEEN Solution ™ hearts

The relevant teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method for perfusing a heart, comprising the step of perfusing the heart with a polymerized hemoglobin-based oxygen carrier solution.

2. The method of claim 1, wherein the polymerized hemoglobin-based oxygen carrier solution includes a polymerized hemoglobin component that has a molecular weight in a range of between about 65 kilodaltons (kDa) and about 800 kDa.

3. The method of claim 2, wherein the polymerized hemoglobin-based oxygen carrier solution is perfused through the heart in a Langendorff mode.

4. The method of claim 2, wherein the polymerized hemoglobin-based oxygen carrier solution is perfused through the heart in a working heart perfusion mode.

5. The method of claim 2, wherein the polymerized hemoglobin-based oxygen carrier solution further includes an organ preservation solution component.

6. The method of claim 5, wherein the polymerized hemoglobin component is pyridoxylated.

7. The method of claim 1, wherein the polymerized hemoglobin component is polymerized with at least one member of the group consisting of aldehydes and saccharides.

8. The method of claim 7, wherein the polymerized hemoglobin component is polymerized with gluteraldehyde.

9. The method of claim 8, wherein the component that has an oxygen p50 of greater than about 30 mmHg.

10. The method of claim 9, wherein the polymerized hemoglobin input has an oxygen p50 of greater than about 35 mmHg.

11. The method of claim 10, wherein the polymerized hemoglobin component has an oxygen p50 of about 40 mmHg.

12. The method of claim 9, wherein the polymerized hemoglobin component has a viscosity of less than about 4 cP.

13. The method of claim 12, wherein the polymerized hemoglobin input has a viscosity of less than about 3 cP.

14. The method of claim 13, wherein the polymerized hemoglobin component has viscosity of less than bout 2.5 cP.

15. The method of claim 14, wherein the polymerized hemoglobin component has a viscosity of about 2.4 cP.

16. The method of claim 5, wherein the organ preservation solution includes at least one member of the group consisting of a colloid component, a metabolite component and an electrolyte aldehyde component.

17. The method of claim 16, wherein the organ preservation solution component is present in the polymerized hemoglobin based oxygen carrier solution in an amount in a range of between about ten percent and about seventy-five percent by volume.

18. The method of claim 1, wherein the heart is perfused in vivo.

19. The method of claim 1, wherein the heart is perfused ex vivo.

20. The method of claim 19, wherein the heart is perfused by directing the polymerized hemoglobin solution into the heart through a left atrium of the heart.

21. The method of claim 19, wherein the heart is perfused by directing the polymerized hemoglobin solution into the heart through an aorta of the heart.

22. The method of claim 1, wherein the temperature of the hemoglobin-based oxygen carrier solution is in a range of between about 4° C. and about 40° C.
